(19) United States
(12) Patent Application Publication
(10) Pub. No.: US 2024/0383591 A1
(43) Pub. Date: Nov. 21, 2024

(54) UNDERWATER DOCKING STATION

(71) Applicant: Heliopolis Holdings Limited, Northwood, Middlesex (GB)

(72) Inventors: Hussein MESHARAFA, Giza (EG); Abdelrahman EL MARADNY, Alexandria (EG)

(73) Assignee: Heliopolis Holdings Limited, Northwood, Middlesex (GB)

(21) Appl. No.: 18/685,733

(22) PCT Filed: Aug. 19, 2022
(86) PCT No.: PCT/IB2022/020060

§ 371 Date: Feb. 22, 2024

(30) Foreign Application Priority Data
Aug. 27, 2021 (IT) 102021000022478

(51) Int. Cl. B63G 8/00; E02B 17/00; H04B 10/25

(52) U.S. Cl. CPC B63G 8/001; E02B 17/00; B63G 2008/008; H04B 10/25891

(57) ABSTRACT

An underwater docking station for communication with underwater devices. The underwater docking station comprises a support structure and an optical communication module configured for communication with said underwater devices along an optical communication axis. The station also comprises an actuator active on the optical communication module to move the optical communication axis between operative positions, wherein, in the first operative position, the communication axis is directed along a first communication direction, and, in the second operative position, the communication axis is directed along a second communication direction different from the first communication direction. The station further comprises a control unit connected to the optical communication module to manage a communication with said underwater devices, and the actuator to drive the optical communication axis to the first operative position and to the second operative position.

### FIELD OF THE INVENTION

The present disclosure refers to an underwater docking station for cooperating with underwater devices, such as ROVs and AUVs. The underwater docking station is configured to lie on the seabed, optionally in communication with a surface vehicle, such as a boat or a ship, either wired (via a cable connection) or wirelessly.

### BACKGROUND

Underwater vehicles are used for a wide variety of operations that include—but are not limited to inspection/identification, oceanography, survey missions or samples picking. Underwater vehicles may be manned or unmanned. Among the unmanned vehicles, there are ROVs and AUVs. An Autonomous Underwater Vehicle (AUV) is a robot that travels underwater without requiring input from an operator. AUVs constitute part of a larger group of undersea systems known as unmanned underwater vehicles, a classification that includes the mentioned non-autonomous Remotely Operated underwater Vehicles (ROVs)—controlled and powered from the surface by an operator/pilot via an umbilical or using remote control. ROVs are unmanned underwater vehicles connected to a base station, which may be a ship. As mentioned ROVs are connected to the ship by means of cables; this implies that the maximum achievable distance between the ROV and the base station is limited by the length of the cable. AUVs are unmanned underwater vehicles, which are connected to a docking station by means of a wireless communication. Typically, AUVs are propelled through the energy stored in batteries housed in their body. This means that the operative range of an AUV is limited by the capacity of the battery.

This type of underwater vehicles has recently become an attractive alternative for underwater search and exploration since they are cheaper than manned vehicles. Over the past years, there have been abundant attempts to develop underwater vehicles to meet the challenge of exploration and extraction programs in the oceans. Recently, researchers have focused on the development of AUVs for long-term data collection in oceanography and coastal management. The oil and gas industry uses AUVs to make detailed maps of the seafloor before they start building subsea infrastructure; pipelines and sub-sea completions can be installed in the most cost effective manner with minimum disruption to the environment. The AUV allows survey companies to conduct precise surveys of areas where traditional bathymetric surveys would be less effective or too costly. In addition, post-lay pipe surveys are now possible, which includes pipeline inspection. The use of AUVs for pipeline inspection and inspection of underwater man-made structures is becoming more common.

With the adoption of AUV technology becoming more widespread, the limitations of the technology are being explored and addressed. The average AUV charge lasts about 24-hours on an underwater AUV, but sometimes it is necessary to deploy them for the kinds of several day missions that some unmanned systems are equipped to undertake. Like most robots, the unmanned mechanisms contain batteries that require regular recharging. Docking stations that communicate directly with underwater vehicles, guiding them to where they can recharge and transfer data have been developed. Any data the AUV has gathered, such as images of the seabed, could be uploaded to the docking station and transmitted to home base, which could direct new instructions to the robot.

It is known from WO2018109451 a subsea basket or garage for unmanned underwater vehicles or UUVs, especially autonomous underwater vehicles or AUVs. A basket for hosting an AUV on the seabed comprises a hollow open-topped body. The body surrounds a receptacle into which an AUV that enters the body through the open top can dock for protection, recharging, data download and/or data upload for reprogramming. The open top of the body is closed by a lid movable between a closed and an open position. When the lid is open, an AUV can access the receptacle by moving generally horizontally to under the lid before lowering through the open top of the body and into the receptacle for docking. The lid is then closed onto the body over the docked AUV. The lid is supported and moved by telescopic guideposts driven by actuators that extend vertically from the body to lift the lid into the open position and retract vertically to lower the lid into the closed position. In another embodiment, paired posts may be stowed against opposed sloping sides of the body lying compactly against those sides. When deployed, the posts swing into deployed positions in opposite angular directions about respective pivot axes that are parallel to the respective sides of the body; the posts are part of a lifting frame that further comprises a crossbar in two sections. A respective section of the crossbar is attached to each post such that, when deployed, the sections of the crossbar extend oppositely and orthogonally with respect to the associated posts. Pivots between each post and the attached section of the crossbar allow the sections of the crossbar to collapse compactly against the sloping sides of the body when the posts are stowed away. This prior art does not focus on data exchange between the station and the AUV, but rather defines a complex structure to house and protect the AUV during data exchange and power recharging. However, the proposed structure with several moving parts is complex and may not be really effective. Further, the docking station is designed for very specific and dedicated AUVs.

In addition to the above, any underwater vehicle requiring the need of a wireless communication with the docking station faces at least the problem of the limitations for wireless communications in water. Radio frequencies are significantly attenuated in water. Above some hundreds of KHz, in particular, above 1 MHz, attenuation in water raises significantly and any communication is affected by a link budget loss that limits the communication to some meters or less even with relevant transmission power and antenna gains. In particular, above 1 MHz attenuation in seawater raises with a more than linear law from 30 dB/m to reach about 60 dB/m at frequencies of about 10 MHz. Lower frequencies, that lay between the ELF (3-30 Hz) up to the LF (30KHz-300KHz) band, and that include acoustic and/or ultrasonic frequencies, are significantly less attenuated in water.

Exploiting low frequencies for signal transmission implies significant limitations in bandwidth, which may be so reduced that even the voice may have some problem to be transmitted. In practice, with LF frequencies transmissions can take place at some hundreds of meters, while ELF transmissions can be effectively performed at longer distances.

Underwater wireless communication may be performed by means of an optical communication system. Optical communication is affected by water turbidity, and the performance of an effective communication is affected by the type of modulation used for the optical radiation. In any case, it is known that through the optical communications some tens of meters at most can be reached in seawater. Optical communication, due to the high frequency of the carrier(s), provides high bandwidth that allows providing video streaming and/or high-definition images transmission with low latencies.

The Applicant further notices that an effective control of complex underwater vehicles necessitates a predetermined communication structure. An improved docking station appears necessary to allow AUV data collection efficiently, to permit reliable commands exchange, AUVs recharging and control. Further, an easily configurable docking station is desirable for coupling and interaction with different type of underwater devices.

### OBJECT

The purpose of the present disclosure is to provide an underwater docking station for communication with one or more underwater devices configured to overcome the aforementioned drawbacks.

One aim of the disclosure is to allow flexibility in submarine communication with a variety of different submarine devices that can be configured and housed in or at the docking station.

A further purpose of the invention is to allow rapid configuration between different operating positions of the docking station to not only accommodate and hold an AUV in place, but also to be able to receive, and (e.g., mechanically) couple and communicate with a ROV, and possibly interact with both devices simultaneously.

A further aim is to allow communication with the underwater device(s) over long distances and/or with sufficient bandwidth and to allow data transfer at high speed (e.g., video data transfer), too.

An auxiliary aim is to provide a docking station that may be easily reconfigured for mechanically and/or communicatively coupling with different AUVs and/or ROVs.

### SUMMARY

These and further purposes of the present disclosure are obtained by means of an underwater docking station for communication with one or more underwater devices as here disclosed. Several principal aspects of the present disclosure will be hereinafter described. The following aspects can be combined together or with any part of the detailed description, in any suitable form.

In accordance with an independent aspect, an underwater docking station for communication with one or more underwater devices is described comprising:
a support structure (2);
an optical communication module (3) configured for communication with said one or more underwater devices (4) along an optical communication axis (5);
a coupling arrangement (6) mounting the optical communication module (3) to the support structure (2);
an actuator (7) active on the optical communication module (3) to move the optical communication axis (5) between at least one first operative position and one second operative position, wherein, in the first operative position, the communication axis (5) is directed along a first communication direction (8) and, in the second operative position, the communication axis (5) is directed along a second communication direction (9) different from the first communication direction (8);
a control unit (10) connected to:
   the optical communication module (3) to manage a communication with said one or more underwater devices (4), and
   the actuator (7) to drive the optical communication axis (5) to the first operative position and to the second operative position.

In accordance with a further independent aspect, an underwater docking station for communication with one or more underwater devices is described comprising:
a support structure (2) comprising:
   a base portion (2a),
   a top portion (2b),
   a mechanism (15) interposed between the base portion (2a) and the top portion (2b) to allow moving the base portion (2a) away from the top portion (2b) defining an housing space (16) for receiving the underwater device (4) between the base portion (2a) and the top portion (2b) and to allow reducing or removing the housing space (16) defining a compact configuration of the underwater docking station, and
   a reversible actuator active on the mechanism (15) to increase or reduce the housing space (16) by approaching or distancing the base portion (2a) and the top portion (2b);
a communication module including either or both an optical communication module (3) configured for communication with said one or more underwater devices (4) along an optical communication axis (5) and/or an acoustic module for communication with said one or more underwater devices (4);
a coupling arrangement (6) mounting the communication module to the support structure (2);
a control unit (10) connected to:
   the communication module to manage a communication with said one or more underwater devices (4), and
   the reversible actuator to drive the mechanism (15) for approaching or distancing the base portion (2a) and the top portion (2b).

In a 2^{nd} aspect according to the previous aspects, the actuator (7) is active to move the optical communication module (3) or a portion of the optical communication module (3) to move the optical communication axis (5) between the first and the second operative position.

In a 3^{rd} aspect according to any one of the previous aspects, the coupling arrangement (6) movably mounts the optical communication module (3) to the support structure (2), in particular the actuator (7) being active to the coupling arrangement (6) to move the optical communication axis (5) between the first operative position and the second operative position, in particular the optical communication module (3) being associated to a top portion (2a) of the support structure (2).

In a 4^{th} aspect according to any one of the previous aspects, the optical communication module (3) is configured to communicate on a line of sight along the communication axis (5) with another optical communication module (13) of one of the one or more underwater devices (4) with respective communication axis aligned on the line of sight.

In a 5^{th} aspect according to any one of the previous aspects, the optical communication module (3) is configured to at least rotate along a rotation axis (11) that is transversal, in particular orthogonal, to the communication axis (5).

In a 6^{th} aspect according to previous aspect 5, the rotation axis (11) is substantially horizontal in use conditions of the underwater docking station (1).

In a 7^{th} aspect according to any one of the previous aspects, the actuator (7) is configured to rotate the optical communication module (3) to move the optical communication axis (5) between the first operative position and the second operative position.

In a 8^{th} aspect according to any one of the previous aspects, the optical communication axis (5) is movable in a plurality of additional positions in addition to the first operative position and the second operative position, the optical communication module (3) is configured to communicate along additional communication direction in one or more of said additional positions.

In a 9^{th} aspect according to previous aspect 8, the additional communication direction lies in a vertical plane in use condition of the underwater docking station (1).

In a 10^{th} aspect according to any one of the previous aspects, the first communication direction (8) is directed substantially vertically in use condition of the underwater docking station (1), optionally the second communication direction (9) is directed substantially vertically in use condition of the underwater docking station (1), for example the first communication direction (8) is directed upwards and the second communication direction (9) is directed downwards.

In an 11^{th} aspect according to any one of the previous aspects, the control unit (10) is configured to command the actuator (7) exclusively to rotate the optical communication module (3) and move the optical communication axis (5) along a vertical plane in use condition of the underwater docking station (1), in particular, the control unit (10) is configured to rotate over a rotation angle range of at least 90° and in particular of at least 180°.

In a 12^{th} aspect according to any one of the previous aspects, the optical communication module (3) comprises a wireless optical modem.

In a 13^{th} aspect according to any one of the previous aspects, the optical communication module (3) has a maximum communication range of about 60 m.

In a 14^{th} aspect according to any one of the previous aspects, the optical communication module (3) has a data rate of at least 5 Mbit/sec, in particular of at least 9/10 Mbit/sec.

In a 15^{th} aspect according to any one of the previous aspects, the optical communication module (3) is configured for working at least up to a depth of 6000 m.

In a 16^{th} aspect according to any one of the previous aspects, the optical communication module (3) is a bi-directional transceiver.

In a 17^{th} aspect according to any one of the previous aspects, the optical communication module (3) is configured for achieving video data transfer, for example for 4K video data transfer.

In an 18^{th} aspect according to any one of the previous aspects, the support structure (2) comprises a base portion (2a) and a top portion (2b).

In a 19^{th} aspect according to any one of the previous aspects, the support structure (2) is configured for supporting the underwater docking station on the seabed, the underwater docking station being a seabed underwater docking station.

In a 20^{th} aspect according to any one of the previous aspects, the support structure (2) comprises a base portion (2a) including a support plate (12) for resting on the seabed.

In a 21^{st} aspect according to the previous aspect, the support plate (12) has:
a grid structure showing a plurality of lightening holes; and/or
a guide (14) for guiding the underwater device (4) when received by the underwater docking station (1); and/or
a locking mechanism (15a), such as a projection, for allowing the underwater device (4) to lock to the underwater docking station (1).

In a 22^{nd} aspect according to any one of the previous aspects, the support structure (2), and in particular a base portion (2a) of the support structure, comprises:
a guide (14) for guiding the underwater device (4) when received by the underwater docking station (1); and/or
a locking mechanism (15a), such as a projection, for allowing the underwater device (4) to lock to the underwater docking station (1).

In a 23^{rd} aspect according to any one of the previous aspects, the support structure (2) comprises a base portion (2a) and a top portion (2b) and a mechanism (15) interposed between the base portion (2a) and the top portion (2b) to allow moving the base portion (2a) away from the top portion (2b) defining an housing space (16) for receiving the underwater device (4) between the base portion (2a) and the top portion (2b) and to allow reducing or removing the housing space (16) defining a compact configuration of the underwater docking station, in particular the underwater docking station further comprising a reversible actuator active on the mechanism (15) to increase or reduce the housing space (16) by approaching or distancing the base portion (2a) and the top portion (2b).

In a 24^{th} aspect according to the previous aspect, the mechanism (15) comprises at least one scissor mechanism including a first bar and a second bar hinged to each other at a respective intermediate point, in particular the first bar has a fixed portion hinged to the base portion (2a) and a movable portion slidable along the top portion (2b) and the second bar has a fixed hinged to the top portion (2b) and a movable portion slidable along the base portion (2a).

In a 25^{th} aspect according to the previous aspect 23, the mechanism (15) comprises at least two scissor mechanisms, each respectively including a first bar and a second bar hinged to each other at a respective intermediate point, in particular the first bar has a fixed portion hinged to the base portion (2a) and a movable portion slidable along the top portion (2b) and the second bar has a fixed portion hinged to the top portion (2b) and a movable portion slidable along the base portion (2a), for example one first scissor mechanism being on one lateral side of the underwater docking station, and one second scissor mechanism being on an opposite lateral side of the underwater docking station.

In a 26^{th} aspect according to the previous two aspects, the support structure (2), and in particular the base portion (2a), includes a sliding seat (17), the movable portion of one between the first bar and the second bar sliding within the sliding seat (17).

In a 27^{th} aspect according to the previous three aspects, the support structure (2), and in particular the top portion (2b), includes a guide (18), the movable portion of one between the first bar and the second bar sliding over the guide (18).

In a 28^{th} aspect according to the previous five aspects, the reversible actuator comprises a motor and a guide (18) in the form of an endless screw, the motor rotating the endless screw in one or the opposite direction to achieve increasing or reducing the housing space (16).

In a 29^{th} aspect according to the previous aspect, the endless screw is rotatably coupled to the top portion (2a), a threaded head (19) being fixed to a movable portion of a first bar of the mechanism (15), being coupled to and moving over the endless screw.

In a 30^{th} aspect according to any one of the previous aspects, the docking station further comprises a camera (20) associated to the support structure (2) to allow viewing and/or filming of images surrounding the underwater docking station in a field of view.

In a 31^{st} aspect according to the previous aspect, the docking station further comprises a camera actuator (21) active on the camera (20) to move an axis of the field of view between different operative positions having the axis of the field of view of the camera (20) directed along different directions, the control unit (10) being connected to:
the camera (20) to manage viewing and/or filming, and
the camera actuator (21) to move the axis of the field of view of the camera (20) between the operative positions.

In a 32^{nd} aspect according to the previous aspect, the camera (20) is configured to at least rotate along a rotation axis (11) that is transversal, in particular orthogonal, to the axis of the field of view of the camera (20).

In a 33^{rd} aspect according to the previous aspect, the rotation axis (11) is substantially horizontal in use conditions of the underwater docking station (1).

In a 34^{th} aspect according to the previous three aspects, the control unit (10) is configured to command the camera actuator (21) exclusively to rotate the camera (20) and move the axis of the field of view of the camera (20) along a vertical plane in use condition of the underwater docking station (1), in particular, the control unit (10) is configured to rotate over a rotation angle range of at least 90° and in particular of at least 180°.

In a 35^{th} aspect according to any one of the previous aspects, the docking station further comprises one or more LEDs (22) associated to the support structure (2) to allow illuminating the surroundings of the underwater docking station (1), in particular the LEDs being associated to a top portion (2a) of the support structure (2).

In a 36^{th} aspect according to any one of the previous aspects, the docking station further comprises a hydrophone (23) configured to allow a transmission and reception of ultrasonic and/or acoustic signals, the control unit (10) being connected to said hydrophone (23) to manage communication with ultrasonic and/or acoustic signals, in particular the hydrophone (23) being associated to a top portion (2a) of the support structure (2).

In a 37^{th} aspect according to the previous aspect, the transmission of the ultrasonic and/or acoustic signals is a substantially non-directive transmission, the control unit (10) being configured to transmit with the hydrophone (23) when the underwater docking station (1) and the underwater vehicle (4) are at a first distance (D1), and wherein a transmission of optical signals through the optical communication module (3) is a substantially directive transmission, the control unit (10) being configured to transmit with the optical communication module (3) when the underwater docking station (1) and the underwater vehicle (2) are at a second distance (D2), the first distance (D1) being greater than the second distance (D2).

In a 38^{th} aspect according to the previous aspect, the second distance (D2) is lower than 100 m, preferably lower than 80 m, preferably lower than 60 m, optionally the first distance (D1) being lower than 500 m, preferably lower than 300 m, preferably lower than 200 m.

In a 39^{th} aspect according to any one of the previous two aspects, the control unit (10) is configured to:
receive or determine a distance between the underwater docking station (1) and the underwater device (4),
select a communication using either the hydrophone (23) or the optical communication module (3) based on said distance.

In a 40^{th} aspect according to any one of the previous four aspects, the communication with ultrasonic and/or acoustic signals has low data transfer rate and the communication with optical signals through the optical communication module (3) has high data transfer rate, the low data transfer rate being lower than the high data transfer rate.

According to a further non-limiting aspect in combination with any of the previous aspects, an activation of the hydrophone (23) and/or an activation of the optical communication module (3) comprises the control unit (10) configured for measuring and/or electronically calculating a distance between the underwater docking station (1) and the underwater device (4) and the activation of the hydrophone (23), or the transmission of the ultrasonic and/or acoustic signal by means of the hydrophone (23) takes place when the underwater docking station (1) and the underwater device (4) are at a first distance (D1), and the activation of the optical communication module (3) and/or the step of transmission of the optical signal by the optical communication module (3) takes place when the underwater docking station (1) and the underwater device (4) are at a second distance (D2).

According to a further non-limiting aspect in combination with any of the previous aspects, the control unit (10) is configure for adapting and/or configuring the hydrophone (23) in order to allow a transmission and reception of ultrasonic and/or acoustic signals; the hydrophone (23) comprises at least one between a vibrator and/or an amplifier, the vibrator and/or the amplifier being specifically configured to allow the transmission of an ultrasonic and/or acoustic signal, in particular an high power transmission of the ultrasonic and/or acoustic signal.

According to a further non-limiting aspect in combination with any of the previous aspects, the control unit (10) is configured to transmit the ultrasonic and/or acoustic signal by means of the hydrophone (23) and to provide a signal to said vibrator and/or to said amplifier and/or to a piezoelectric transducer of the hydrophone (23).

According to a further non-limiting aspect in combination with any of the previous aspects, the control unit (10) is configured to define a plurality of frequency-spaced transmission channels (Ch1, Ch2, Ch3) of ultrasonic and/or acoustic signal transmission and to transmit the ultrasonic and/or acoustic signal on said plurality of frequency-spaced transmission channels (Ch1, Ch2, Ch3), in particular to transmit simultaneously on said plurality of frequency-spaced transmission channels (Ch1, Ch2, Ch3) optionally to transmit the ultrasonic and/or acoustic signal takes place according to a FSK modulation, or an ASK modulation, or a PSK modulation.

According to a further non-limiting aspect in combination with any of the previous aspects, the ultrasonic and/or acoustic signal comprises a plurality of 0s and 1s and the transmission of the ultrasonic and/or acoustic signal according to the FSK modulation comprises modulating the 0s and the 1s respectively on a first and a second carrier frequency spaced one with respect to the other, said first and second carrier frequencies being spaced of a predefined guard interval.

According to a further non-limiting aspect in combination with any of the previous aspects, the control unit (10) is configured to adapt the predefined guard interval and/or adapt said first and/or second carrier frequency.

According to a further non-limiting aspect in combination with any of the previous aspects, the guard interval is at least 5 kHz or at least 10 kHz.

According to a further non-limiting aspect in combination with any of the previous aspects, the control unit (10) is configured to perform a synchronization of the control and/or of the motion of the underwater device (4) with respect to the underwater docking station (1),
the synchronization taking place by means of the ultrasonic and/or acoustic signal,
the transmission of the ultrasonic and/or acoustic signal comprising the control unit configured to transmit control and/or motion data on at least one data channel (Ch1, Ch2) of the plurality of frequency-spaced transmission channels (Ch1, Ch2, Ch3) and/or to transmit synchronization data on at least one synchronization channel (Ch3) of the plurality of frequency-spaced transmission channels (Ch1, Ch2, Ch3).

According to a further non-limiting aspect in combination with any of the previous aspects, the control unit (10) is configured to provide the ultrasonic and/or acoustic signal with a noise portion and a payload portion, the control unit (10) is configured to provide underwater noise mitigation, for reducing the noise portion and/or increasing a signal-to-noise ratio of the ultrasonic and/or acoustic signal.

According to a further non-limiting aspect in combination with any of the previous aspects, the underwater noise mitigation (control unit configuration) comprises at least one among:
selecting, optionally automatically, a frequency range for transmitting the ultrasonic and/or acoustic signal, the frequency range being far from underwater noise sources;
providing the underwater docking station (1) with a plurality of hydrophones (23), and/or providing the underwater device (4) with a further plurality of hydrophones and simultaneously receiving the ultrasonic and/or acoustic signal with the plurality of hydrophones (23) and with the further plurality of hydrophones, the plurality of hydrophones (23) and/or the further plurality of hydrophones comprising hydrophones arranged at different positions and/or at different angles;
electronically processing a received ultrasonic and/or acoustic signal by means of noise mitigation software and/or hardware, performing at least one of the signals processing of the following list: a frequency-based noise mitigation processing, in particular a Fast Fourier Transform noise mitigation processing; a matrix factorization noise mitigation processing; an adaptive and/or predictive filtering for noise mitigation.

According to a further non-limiting aspect in combination with any of the previous aspects, the control unit (10) is configured to transmit at least one between said ultrasonic and/or acoustic signal and said optical signal by transmission of a numeric signal, optionally a binary and/or a packet-type numeric signal, comprising a message having a structure including at least one of the fields of the following list: a command type field, containing data relating to the type of command provided to, or received by, the underwater device (4); a payload field, containing data associated to said type of command provided to, or received by, the underwater device (4); a message number identification field; a checksum field.

According to a further non-limiting aspect in combination with any of the previous aspects, the underwater docking station (1) and/or the underwater device (4) comprises at least one position and/or direction sensing element configured to provide indication of a position and/or orientation respectively of the underwater docking station (1) and/or of the underwater device (2).

In a 41^{st} aspect according to any one of the previous aspects, a top portion (2a) of the support structure is substantially flat and configured to receive in support an underwater device (4).

In a 42^{nd} aspect according to any one of the previous aspects, the docking station further comprises a wireless recharge module configured to couple to a corresponding wireless recharge module of the underwater device (4) to charge a battery of the underwater device (4).

In a 43^{rd} aspect according to the previous aspect, the wireless recharge module is configured to recharge the battery of the underwater device (4) if the corresponding wireless recharge module of the underwater device is at a distance from the wireless recharge module of less than 0.5 m, in particular when the underwater device (4) is in a housing space (16) of the support structure (2).

In a 44^{th} aspect according to any one of the previous aspects, the docking station further comprises a battery associated to the support structure (2) to provide electric power to the control unit (10), to the optical communication module (3) and to the actuator (7).

In a 45^{th} aspect according to the previous aspect, the battery of the underwater docking station is rechargeable, e.g., wirelessly, through the one or more underwater devices (4) that provides electric power.

### FIGURES

In the subsequent detailed description, a preferred embodiment of the underwater docking station according to the present disclosure will be presented. The detailed description refers to the annexed figures; a brief description thereof is here presented.

FIG. 1 shows a front perspective view of an underwater docking station according to the present disclosure in a partially open condition;

FIG. 2 shows a rear perspective view of the underwater docking station of the present disclosure;

FIG. 3 shows another front perspective view of the underwater docking station according to the present disclosure in a fully open condition;

FIG. 4 shows an underwater system including the underwater docking station of FIG. 3 when ready to receive an underwater device in the form of an AUV;

FIG. 5 shows the underwater system of FIG. 4 further including another underwater device in the form of a ROV coupled to the top portion of the underwater docking station of the present disclosure;

FIG. 6 shows a lateral view of the underwater docking station of the present disclosure in the open condition;

FIG. 6A shows a lateral view of the underwater docking station of the present disclosure in the closed condition;

FIG. 7 shows a front view of the underwater docking station of the present disclosure with inner components in sight;

FIG. 8 shows a front view of the underwater docking station of the present disclosure;

### DETAILED DESCRIPTION

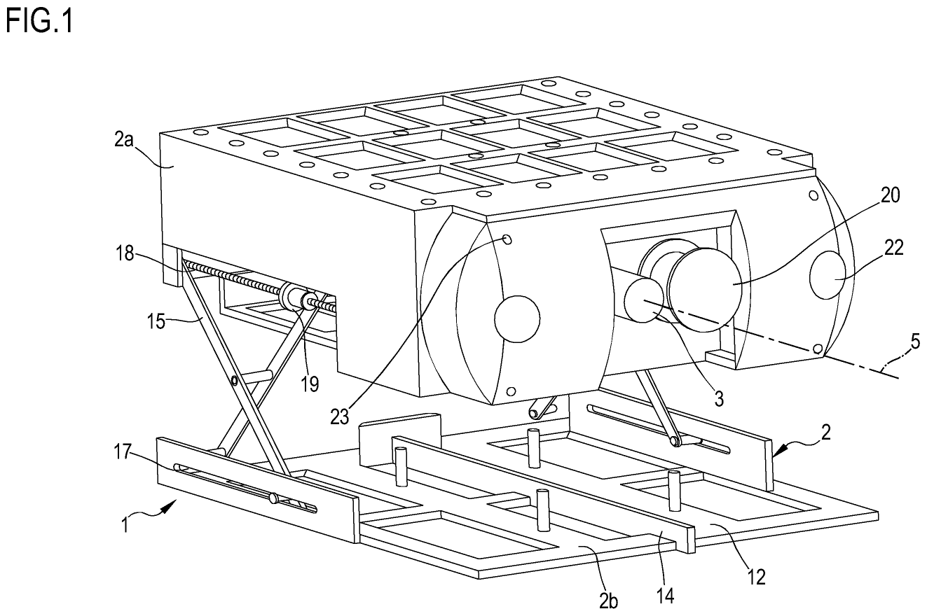

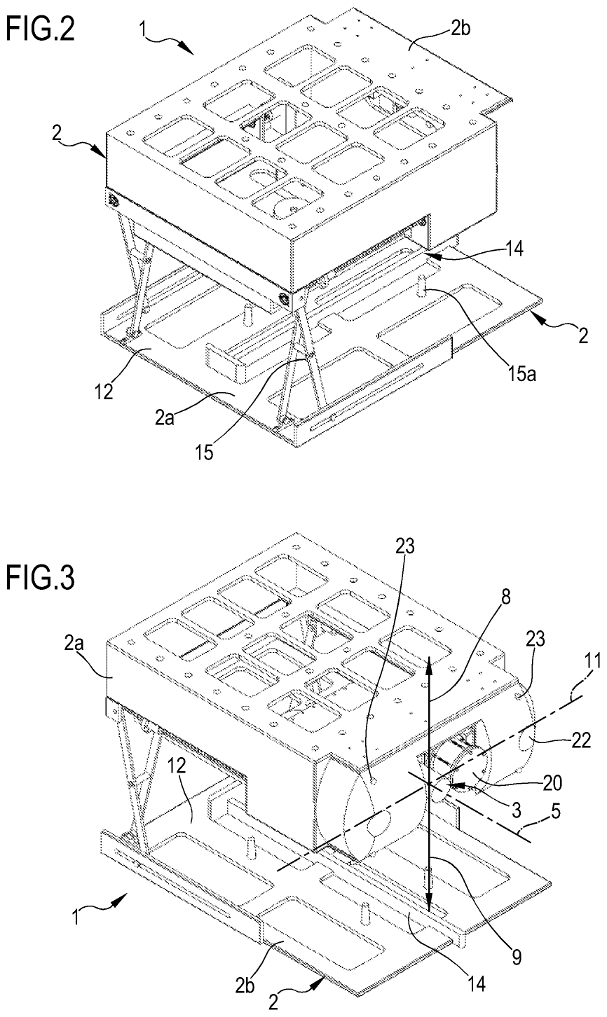

FIG. 1 represents an underwater docking station 1 designed for communication with one or more underwater devices 4 (or underwater vehicles such as AUVs and/or ROVs). Though not limiting, the underwater docking station 1 is primarily a seabed underwater docking station, namely a station that, when operative, is positioned and lies on the seafloor. In this regard, the underwater docking station 1 is designed to resist to water pressure and to water salinity and may also operate at great depths such as 6000 metres below sea level.

The underwater docking station 1 comprises a support structure 2 that defines the frame containing the ‘operative’ elements of the docking station 1 further allowing the station 1 itself to rest on the seabed. The support structure 2 includes a base portion 2a and a top portion 2b interconnected one another.

The portion 2a includes a support plate 12 that is substantially flat for resting on the seabed; the support plate may have any suitable overall dimension, however a length of less than 1 m (for example a length of about 825 mm) and a width of less than 1 m (for example a width of about 625 mm) may be recommended to keep the overall volume sufficiently reduced. The support plate 12 may be rectangular with a ratio of sides between 0.5 and 1 (width/length).

As apparent from the figures (for example FIG. 3), the support plate 12 has a grid structure showing a plurality of lightening holes of e.g., rectangular form. The holes not only reduce the station weight, but also allow a more stable resting on the seabed since ground irregularities may be compensated.

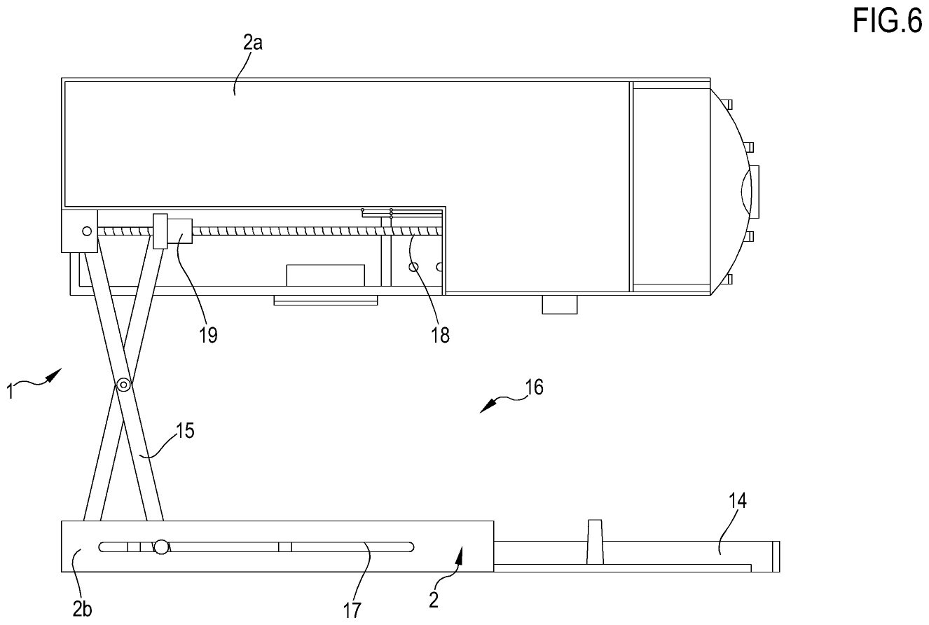

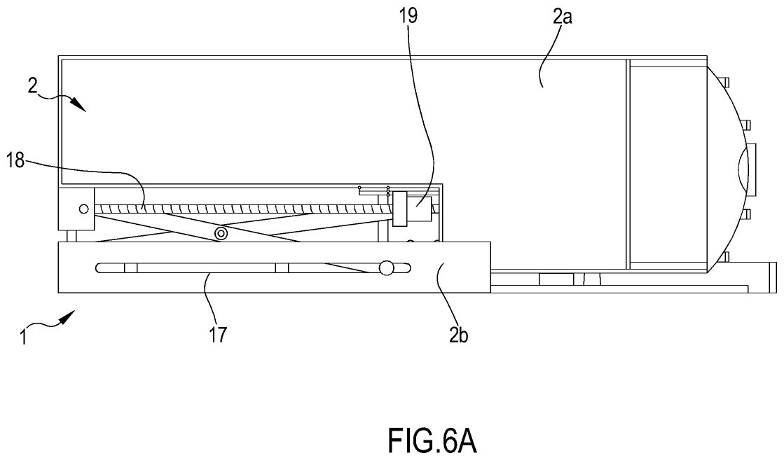

As shown in FIGS. 1 and 6, the support structure 2 comprises a mechanism 15 interposed between the base portion 2a and the top portion 2b to allow moving the base portion 2a away from the top portion 2b defining an housing space 16 for receiving the underwater device 4 between the base portion 2a and the top portion 2b and to allow reducing or removing the housing space 16 defining a compact configuration of the underwater docking station.

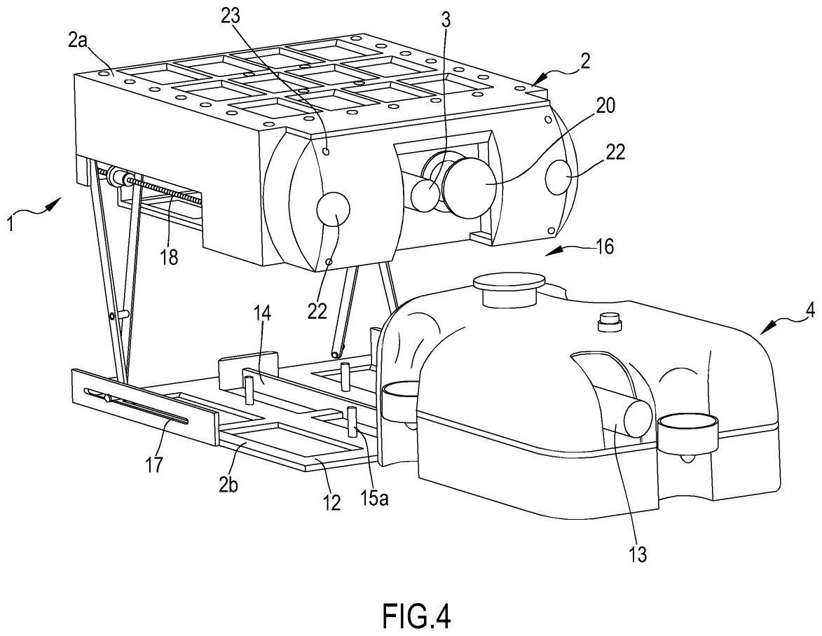

FIG. 6 is a lateral view clearly showing the housing space 16 in the extended configuration of the underwater docking station, in which the top portion 2a is far from the base portion 2b. In FIG. 4, an underwater device 4, such as an AUV, is ready to couple to the docking station by entering into the housing space 16.

Further, the support plate 12 shows a guide 14 in the form of a vertical bar starting from the housing space entrance and heading backwards towards the back of the station; the guide 14 is designed for guiding the underwater device 4 when received by the underwater docking station 1 in the housing space 16 (e.g., avoids that the underwater device 4 hits the scissor mechanism 15 and promotes a correct relative positioning of the underwater device 4 with respect to the docking station, for example for recharging purposes and/or for data exchange as below described in more detail). Obviously, the underwater device 4 has a corresponding seat that receives the emerging guide 14. It is clear that, in an alternative construction, the support plate 12 may include a seat and the underwater device 4 have the emerging guide.

In addition, the support plate 12 shows a locking mechanism 15a, such as one or more projections emerging from the plate 12, for allowing the underwater device 4 to lock to the underwater docking station 1, for example by means of corresponding clamps.

Notably, the support plate 12 may be substituted with a different plate having guide 14 and/or locking mechanism 15a dedicated to a different types/positions of corresponding seat and/or clamps of another underwater device 4.

Going back to the scissor mechanism 15 between the top portion and the base portion, the compact configuration is shown in the lateral view of FIG. 6A. In this situation, the base portion and the top portion are substantially into contact and no space is defined between them (i.e., no underwater device 4 may be housed between the two portions in the docking station). FIG. 6A shows a transport configuration that reduces the overall dimension of the docking station during transportation and/or installation and positioning on the seabed.

In order to automatically switch between the configuration of FIGS. 6 and 6A, the underwater docking station further comprises a reversible actuator active on the mechanism 15 to increase or reduce the housing space 16 by approaching or distancing the base portion 2a and the top portion 2b. In more detail, the mechanism 15 comprises at least two scissor mechanisms, both partially visible in FIG. 1, that are placed at opposite lateral side with respect to the housing space 16. Each scissor mechanism respectively includes a first bar and a second bar hinged to each other at a respective intermediate point. The first bar has a fixed portion hinged to the base portion 2a and a movable portion slidable along the top portion 2b. The top portion 2b includes a guide 18, in the form of an endless screw and the movable portion of the first bar may slide over the guide 18. In this regard, the reversible actuator comprises a motor and the endless screw 18; the motor rotates the endless screw in one direction or in the opposite direction to achieve increasing or reducing the housing space 16. Indeed, the endless screw is rotatably coupled to the top portion 2a and a threaded head 19 fixed to the movable portion of the first bar of the mechanism 15 is coupled to and moving over the endless screw. When the screw is rotated clockwise, the threaded head 19 is dragged in one direction; when the screw is rotated counter clockwise, the threaded head 19 is dragged in the opposite direction.

Differently, the second bar has a fixed portion hinged to the top portion 2b and a movable portion slidable along the base portion 2a. The base portion 2a includes a sliding seat 17 and a pin of the movable portion of the second bar slides within the sliding seat 17 during movement between the open and the closed positions.

By properly actuating the motor and synchronizing the two scissor mechanism 15, it is possible to configure the underwater docking station between the configuration of FIG. 6 and of FIG. 6A (or to achieve any intermediate conditions). When the endless screw is blocked, the scissor mechanism 15 is blocked too and the achieved configuration of the docking station is stable.

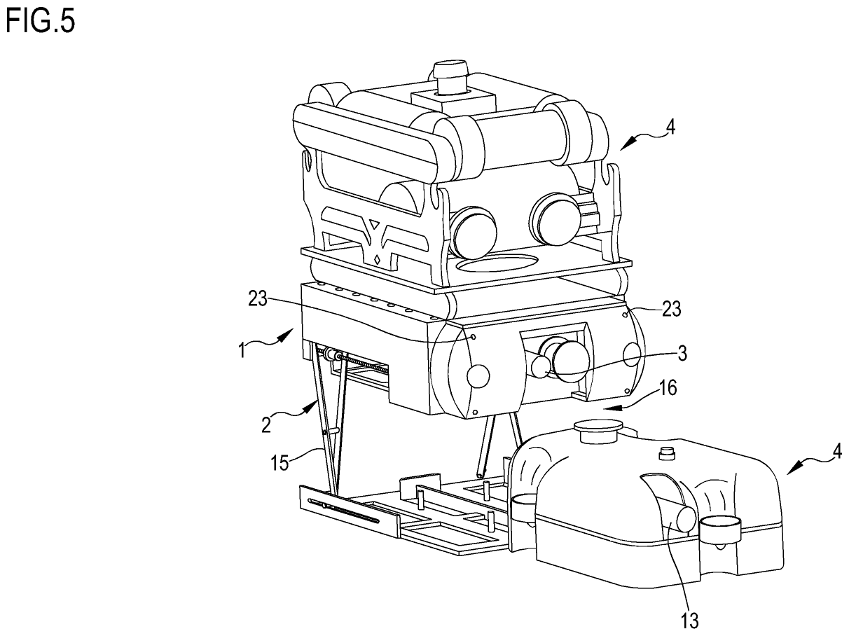

The top portion 2a of the support structure is substantially flat and designed to receive in support another underwater device 4, for example a ROV (see FIG. 5). Also the top panel of the portion 2a may include lightening holes (e.g. rectangular) to reduce weight and to provide undercuts for the ROV coupling and/or clamping (if necessary). Further, the top portion 2a defines a frame that houses a number of electric and electronic components for the working and communication of the docking station.

The top portion 2a usually houses a battery associated to the support structure 2 to provide electric power to various components here after described such as a control unit 10, an optical communication module 3, an acoustic communication module (hydrophones 23), a camera 20, LEDs 22 and the respective actuators. The battery of the underwater docking station is rechargeable, e.g., wirelessly, through the one or more underwater devices 4 that provides electric power. Indeed, the ROV shown in FIG. 5 may be electrically powered by the umbilical cable (e.g., from a surface vehicle) and thereby may wirelessly provide electric power to recharge the battery of the docking station without having to recover the same form the bed floor.

Notably, the support structure 2 further houses a wireless recharge module configured to couple to a corresponding wireless recharge module of the underwater device 4 to charge a battery of the underwater device 4. In this regard, electric power recharge is in the reverse direction, namely towards the underwater device 4, which in this case may be an AUV that has no power connection to the surface vehicle. The wireless recharge module is configured to recharge the battery of the underwater device 4 if the corresponding wireless recharge module of the underwater device is at a distance from the wireless recharge module of less than 0.5 m, in particular when the underwater device 4 is correctly positioned in the housing space 16 of the support structure 2. The recharge module of the underwater device 4 could be used both to receive electric power from e.g., a ROV, and to provide electric power to e.g., an AUV as mentioned.

As visible from FIGS. 4 and 8, the docking station 1 further comprises one or more lights, such as LEDs 22, associated to the support structure 2 in correspondence of the front panel of the top portion 2a to allow illuminating the surroundings of the underwater docking station 1. Two LEDs are shown on opposite sides of the front panel to provide (uniform) light to the front of the station in dark subsea environment. A control unit 10 drives the lights/LEDs and is also used to fully control the docking station working.

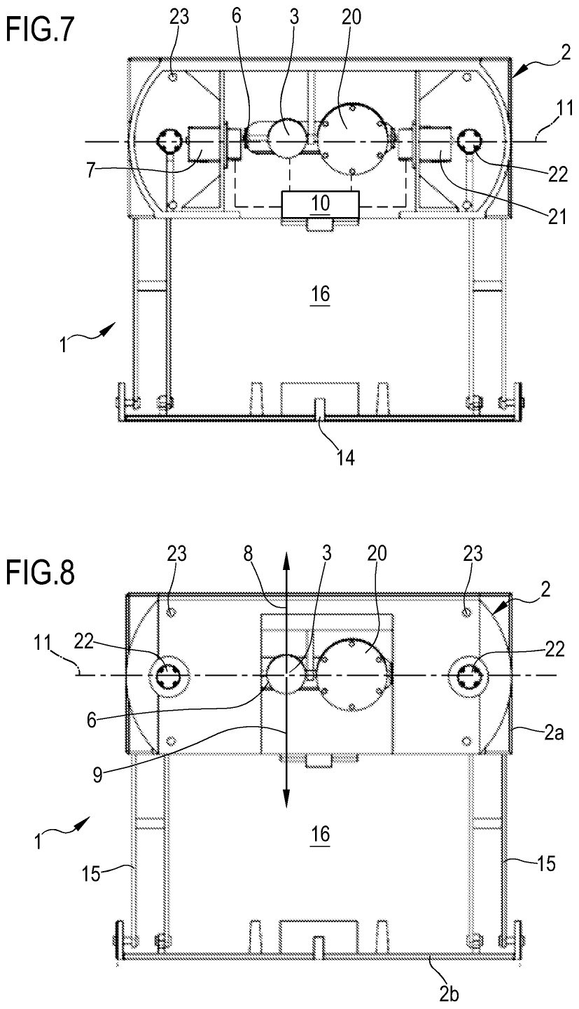

The top portion 2a also houses a camera 20 placed in correspondence of the front panel. The camera 20 is connected to the control unit 10 and allows viewing and/or filming of images surrounding the underwater docking station; the camera has a certain field of view and the collected data may be stored in a memory connected to the control unit 10. As visible in FIG. 7, a camera actuator 21 (e.g., a stepper motor) is active on the camera 20 upon control unit command to move the axis of the field of view between different operative positions, wherein the axis of the field of view of the camera 20 is directed along different directions. In other terms, the camera 20 is not fixed to the support structure but may be moved to look at different areas, specifically to the environment in front of the docking station. For example, images may be used to command the underwater device 4 during working or during approach to the docking station for recharge or data exchange. The camera 20 is configured to at least rotate along a rotation axis 11 that is transversal, and in particular orthogonal, to the axis of the field of view of the camera 20. The rotation axis 11 is substantially horizontal in use conditions of the underwater docking station 1 so that the field of view can be moved from framing the seabed towards the surface by pure rotation around the horizontal axis 11. In other terms, the control unit 10 is configured to command the camera actuator 21 exclusively to rotate the camera 20 and move the axis of the field of view of the camera 20 along a vertical plane in use condition of the underwater docking station 1; for example, the control unit 10 may be configured to rotate over a rotation angle range of at least 90° and in particular of at least 180°.

As it is visible from FIG. 7, the underwater docking station 1 further comprises an optical communication module 3 configured for data communication with one or more underwater devices 4 along an optical communication axis 5. Indeed, the optical communication module 3 is configured to communicate on a line of sight along the communication axis 5 with another optical communication module 1 of the underwater device 4 with its respective communication axis aligned on the line of sight.

The optical communication module 3 comprises a wireless optical modem that in the specific embodiment has a maximum communication range of about 60 m. Of course, maximum distance is affected by water turbidity and environment noise. The optical communication module 3 has a data rate of at least 5 Mbit/sec, in particular of at least 9/10 Mbit/sec and is configured for working at least up to a depth of 6000 m. The optical communication module 3 is a bi-directional transceiver and is configured for achieving video data transfer, for example for 4K video data transfer.

In general terms, the optical communication module 3 is used for transmitting and receiving data at high data rate with good bandwidth using optical signals. For the purposes of the present disclosure, with “optical signal” shall be intended a signal within the range of visible light—about in the [380-750] nm range—and/or in the range of the infrared light—about in the [700-1000] nm range—and/or in the range of the ultraviolet light—about in the range [10-380] nm range. The clause “and/or” is provided since in an embodiment the bandwidth of the optical signal may be so broad to cover at least two or three among the ranges of the visible light, the infrared light, the ultraviolet light.

A coupling arrangement 6 is used to mount the optical communication module 3 to the support structure 2 in order to allow a relative movement between the optical communication module 3 and the support structure. The movement is used to properly orient the communication axis 5 and therefore the line of sight of the optical module. An actuator 7 is shown in FIG. 7 and is active on the optical communication module 3 to move the optical communication axis 5 between (at least) one first operative position and one second operative position, wherein, in the first operative position, the communication axis 5 is directed along a first communication direction 8 and, in the second operative position, the communication axis 5 is directed along a second communication direction 9 that is different from the first communication direction 8. The exemplificative directions are shown in FIGS. 3 and 8. The possibility to move the communication axis is used to allow an easier and more reliable communication between the docking station and the underwater devices 4 according to the position of the specific underwater device 4 with which communication is desired.

As mentioned, an AUV may be housed in the housing space 16 below the top portion 2a (see FIG. 4). When the AUV is in place below the top portion, the communication axis 5 of the optical communication module 3 is rotated downwards from the position shown in FIG. 4 so to reach the second communication direction 9. Correspondingly, the optical module 13 (which may be of the same type as above described) included in the AUV is rotated upwards so that the two modules are in sight and may exchange data.

Differently, when a ROV is positioned on top of the support structure 2 as shown in FIG. 5, the communication axis 5 of the optical communication module 3 is rotated upwards from the position shown in FIG. 5 so to reach the first communication direction 8. If necessary, a corresponding optical communication module (which may be of the same type as above described) included in the ROV is moved to be in line of sight with module 3 and data are exchanged. Given the fact that more than one underwater device 4 may couple with the docking station in different positions, the optical module mobility allows proper communication with all of the same devices 4 simply changing the communication axis. In this regard, the first communication direction 8 and the second communication direction 9 are directed vertically in use condition of the underwater docking station 1; in the example the first communication direction 8 is directed upwards and the second communication direction 9 is directed downwards.

The control unit 10 is connected to the optical communication module 3 to manage the communication with said one or more underwater devices 4, and to the actuator 7 to drive the optical communication axis 5 (by moving the optical communication module 3 or a portion thereof) to the first operative position or to the second operative position. The optical communication module 3 rotates along a rotation axis 11 that is transversal, in particular orthogonal, to the communication axis 5. As visible form the figures, the rotation axis 11 is substantially horizontal in use conditions of the underwater docking station 1, and therefore the actuator 7 is configured to (exclusively) rotate the optical communication module 3 to move the optical communication axis 5 between the first operative position and the second operative position so that any communication directions lie in a vertical plane. In particular, the control unit 10 is configured to rotate over a rotation angle range of at least 90° and more in detail of at least 180°.

Clearly, the optical communication axis 5 is movable to a plurality of additional positions in addition to the first operative position and the second operative position, and the optical communication module 3 is configured to communicate along additional communication directions in one or more of said additional positions. For example, in the configuration of FIG. 1, the communication axis 5 is horizontal and any underwater device 4 placed in front of (and in line of sight with) the docking station may communicate in the shown position of the module 3.

Further, to the above optical communication system, the docking station is further provided with an acoustic communication module. Since the optical module 3 allows for good data transfer rate, but requires line of sight and proximity, the applicant has implemented a second communication module that uses acoustic and/or ultrasound signals. This system may communicate at greater distances than the optical system and does not require line of sight. However, the data transfer is much reduced. Therefore, the acoustic module is mainly used for exchanging commands, while the optical for important and large data transfer (e.g., video files). The combination of an optical communication and of a ultrasonic and/or acoustic communication between the base station 1 and the underwater device 4 allows to exchange high-bandwidth data using the optical signal and to obtain long communication distances, even if at a lower bandwidth, using the ultrasonic and/or acoustic signal, in particular without requesting complex and/or delicate transmitters differing from a differently configured or adapted hydrophone. The ultrasonic and/or acoustic communication and the optical communication constitute two distinct logic channels for allowing a communication between the base station and underwater device 4. The fact that the operative connection of the base station 1 with the underwater device 4 takes place through two logic channels of communication operating at frequencies significantly different each other allows to guarantee that some noise sources that may affect one logic channel do not interfere with the other logic channel; in some embodiments those two logic channels may be used simultaneously for redundancy—especially for redundancy of control—thereby achieving an increase of reliability of communication.

For the purposes of the present disclosure, with “ultrasonic signal” shall be intended a signal whose frequency is higher than 20 kHz, preferably comprised in the interval [20-200] KHz.

For the purposes of the present disclosure, with “acoustic signal” shall be intended a signal whose frequency is equal or lower than 20 kHz, preferably comprised in the interval [0.01-20] kHz, more preferably in the interval [0.02-20] KHz.

It is noted that the ultrasonic and/or acoustic signal is so defined since in an embodiment its bandwidth may be located between the frequency range of the ultrasonic signals and the frequency range of the acoustic signals, or the plurality of carriers of the channels of the signal may be located between the frequency range of the ultrasonic signals and the frequency range of the acoustic signals.

The Applicant actually notices that according to IEEE Communications Magazine, January 2009 “Underwater Acoustic Communication Channels: Propagation Models and Statistical Characterization”, by Milica Stojanovic, Northeastern University, and James Preisig, Woods Hole Oceanographic Institution, the power spectral density of the ambient noise in an underwater environment, at least due to the wind and shipping activity has a minimum substantially located between 20 KHz and 150 kHz, more in particular between 30 kHz and 110 kHz. Thus, in a preferred, non-limiting, embodiment, the frequency range for the ultrasonic and/or acoustic signal may be located in the [20-150] KHz range, preferably in the [30-110] kHz range.

In this regard, the underwater docking station comprises one or more hydrophones 23 associated to the top portion 2a of the support structure 2 and configured to allow a transmission and reception of ultrasonic and/or acoustic signals. The control unit 10 is connected to the hydrophones 23 to manage communication with ultrasonic and/or acoustic signals. Since the transmission of the ultrasonic and/or acoustic signals is a substantially non-directive transmission, the control unit 10 transmits using the hydrophone 23 when the underwater docking station 1 and the underwater vehicle 4 are at more than a first distance D1 (e.g., between 50 m and 500 m or more). Since the transmission of optical signals through the optical communication module 3 is a substantially directive transmission, the control unit 10 transmits with the optical communication module 3 when the underwater docking station 1 and the underwater device 4 are at a second distance D2 (e.g., between 0 m and 60 m). Notably, the first distance D1 is greater than the second distance D2.

In order to properly work, the control unit 10 is configured to receive or determine a distance between the underwater docking station 1 and the underwater device 4, and select a communication using either the hydrophone 23 or the optical communication module 3 based on said calculated or received distance.

Albeit this shall not be considered limiting, in an embodiment the body of the hydrophone 23 is substantially elongated, and defines a main direction of extension that defines substantially a pointing direction or axis of the hydrophone. The hydrophone 23 is specifically configured to operate in a full-duplex communication environment, i.e. wherein simultaneous reception and transmission takes place.

The invention is not limited to the annexed figures. For such reason, the reference numbers provided in the annexed claims are provided for the sole purpose of increasing the intelligibility of the claim, and shall not be construed as limiting.

It is finally clear that several adaptations and additions can be provided to the object of the invention without for this departing from the scope of protection provided by the annexed claims.

1.-15. (canceled)

16. An underwater docking station for communication with one or more underwater devices, the underwater docking station comprising:
a support structure comprising a base portion, a top portion, and a mechanism interposed between the base portion and the top portion to move the base portion away from the top portion and defining a housing space for receiving an underwater device between the base portion and the top portion and to reduce or remove the housing space defining a compact configuration of the underwater docking station;
an optical communication module for communication with said one or more underwater devices along an optical communication axis;
a mechanical coupling mounting the optical communication module to the support structure;
an actuator active on the optical communication module to move the optical communication axis between a first operative position and a second operative position, wherein, in the first operative position, the optical communication axis is directed along a first communication direction and, in the second operative position, the optical communication axis is directed along a second communication direction different from the first communication direction; and
a control unit connected to:
the optical communication module to manage a communication with said one or more underwater devices, and
the actuator to drive the optical communication axis to the first operative position and to the second operative position.

17. The underwater docking station of claim 16, wherein the actuator is active to move the optical communication module or a portion of the optical communication module to rotate the optical communication axis between the first and the second operative position along a rotation axis that is transversal to the optical communication axis,
wherein the optical communication module is configured to communicate on a line of sight along the optical communication axis with another optical communication module of one of the one or more underwater devices with respective communication axis aligned on the line of sight,
the mechanical coupling movably mounting the optical communication module to the support structure, the actuator being active to the mechanical coupling to move the optical communication axis between the first operative position and the second operative position.

18. The underwater docking station of claim 17, wherein the optical communication module is associated to a top portion of the support structure.

19. The underwater docking station of claim 16, wherein the optical communication axis is movable in a plurality of additional positions in addition to the first operative position and the second operative position, the optical communication module is configured to communicate along additional communication direction in one or more of said additional positions, wherein the additional communication direction lies in a vertical plane in use condition of the underwater docking station.

20. The underwater docking station of claim 16, wherein the first communication direction is directed vertically in use condition of the underwater docking station.

21. The underwater docking station of claim 20, wherein the second communication direction is directed vertically in use condition of the underwater docking station, the first communication direction is directed upwards and the second communication direction is directed downwards.

22. The underwater docking station of claim 16, wherein the optical communication module is a bi-directional transceiver and comprises a wireless optical modem having a data rate of at least 5 Mbit/sec.

23. The underwater docking station of claim 16, wherein the optical communication module has a maximum communication range of about 60 m and is configured for working at least up to a depth of 6000 m.

24. The underwater docking station of claim 16, wherein the support structure comprises a base portion including a support plate configured for supporting the underwater docking station on a seabed, the underwater docking station being a seabed underwater docking station.

25. The underwater docking station of claim 24, wherein the base portion of the support structure comprises:
a guide for guiding the underwater device when received by the underwater docking station; and/or
a locking mechanism for allowing the underwater device to lock to the underwater docking station.

26. The underwater docking station of claim 16, wherein the underwater docking station further comprises a reversible actuator active on the mechanism to increase or reduce the housing space by approaching or distancing the base portion and the top portion, wherein the mechanism comprises at least one scissor mechanism including a first bar and a second bar hinged to each other at a respective intermediate point.

27. The underwater docking station of claim 26, wherein the first bar has a fixed portion hinged to the base portion and a movable portion slidable along the top portion and the second bar has a fixed hinged to the top portion and a movable portion slidable along the base portion.

28. The underwater docking station of claim 26, wherein the support structure includes a sliding seat, a movable portion of one between the first bar and the second bar sliding within the sliding seat,
wherein the top portion includes a guide, the movable portion of one between the first bar and the second bar sliding over the guide, and
wherein the reversible actuator comprises a motor and a guide comprising an endless screw, the motor rotating the endless screw in one or the opposite direction to achieve increasing or reducing the housing space.

29. The underwater docking station of claim 28, wherein the endless screw is rotatably coupled to the top portion, a threaded head being fixed to a movable portion of a first bar of the mechanism, being coupled to and moving over the endless screw.

30. The underwater docking station of claim 16, further comprising:
a camera associated to the support structure to allow viewing and filming of images surrounding the underwater docking station in a field of view; and
a camera actuator active on the camera to move an axis of the field of view between different operative positions having the axis of the field of view of the camera directed along different directions, the control unit being connected to:
the camera to manage viewing and filming, and
the camera actuator to move the axis of the field of view of the camera between the operative positions;
wherein the camera is configured to at least rotate along a rotation axis that is transversal to the axis of the field of view of the camera.

31. The underwater docking station of the previous claim 30, wherein the control unit is configured to command the camera actuator exclusively to rotate the camera and move the axis of the field of view of the camera along a vertical plane in use condition of the underwater docking station, the control unit is configured to rotate over a rotation angle range of at least 90°.

32. The underwater docking station of claim 16, further comprising a hydrophone configured to allow a transmission and reception of ultrasonic and acoustic signals, the control unit being connected to said hydrophone to manage communication with ultrasonic and acoustic signals, the hydrophone being associated to a top portion of the support structure.

33. The underwater docking station of claim 32, wherein the transmission of the ultrasonic and acoustic signals is a non-directive transmission, the control unit being configured to transmit with the hydrophone when the underwater docking station and an underwater vehicle are at a first distance, and wherein a transmission of optical signals through the optical communication module is a directive transmission, the control unit being configured to transmit with the optical communication module when the underwater docking station and the underwater vehicle are at a second distance, the first distance being greater than the second distance, wherein the second distance is lower than 100 m, the first distance being lower than 500 m, and
wherein the control unit is configured to:
receive or determine a distance between the underwater docking station and the underwater device,
select a communication using either the hydrophone or the optical communication module based on said distance.

34. An underwater docking station for communication with one or more underwater devices, the underwater docking station comprising:
a support structure comprising a base portion, a top portion and a mechanism interposed between the base portion and the top portion to move the base portion away from the top portion defining an housing space for receiving an underwater device between the base portion and the top portion and to reduce or remove the housing space defining a compact configuration of the underwater docking station;
an optical communication module for communication with said one or more underwater devices along an optical communication axis;
a mechanical coupling mounting the optical communication module to the support structure;
an actuator active on the optical communication module to move the optical communication axis between a first operative position and a second operative position, wherein, in the first operative position, the optical communication axis is directed along a first communication direction and, in the second operative position, the optical communication axis is directed along a second communication direction different from the first communication direction;
a hydrophone configured to allow a transmission and reception of acoustic signals; and
a control unit connected to:
the optical communication module to manage a communication with said one or more underwater devices, wherein a transmission of optical signals through the optical communication module is a directive transmission, the actuator to drive the optical communication axis to the first operative position and to the second operative position,
hydrophone to manage communication with acoustic signals, wherein the transmission of ultrasonic and acoustic signals is a non-directive transmission,
the control unit being configured to:
transmit with the hydrophone when the underwater docking station and an underwater vehicle are at a first distance,
transmit with the optical communication module when the underwater docking station and the underwater vehicle are at a second distance, the first distance being greater than the second distance,
receive or determine a distance between the underwater docking station and the underwater device,
select a communication using either the hydrophone or the optical communication module based on said distance.

35. The underwater docking station of claim 34, wherein the communication with acoustic signals has data transfer rate lower than data transfer rate of the communication with optical signals through the optical communication module, the control unit being configured to:
define a plurality of frequency-spaced transmission channels of acoustic signal transmission,
transmit the acoustic signal simultaneously on said plurality of frequency-spaced transmission channels, wherein transmission of the acoustic signal takes place according to a FSK modulation, or an ASK modulation, or a PSK modulation.
